(19) United States
(12) Patent Application Publication
(10) Pub. No.: US 2007/0176715 A1
(43) Pub. Date: Aug. 2, 2007

(54) ELECTROMECHANICAL SWITCH

(75) Inventor: Yoshito Nakanishi, Osaka (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 11/626,857

(22) Filed: Jan. 25, 2007

(30) Foreign Application Priority Data
Feb. 2, 2006 (JP) 2006-025855
Jan. 15, 2007 (JP) 2007-006150

(51) Int. Cl. H01H 51/22

(52) U.S. Cl. 335/78

(57) ABSTRACT

An electromechanical switch, includes a substrate, a beam which is mounted on the substrate at both end parts thereof, a first driving electrode which is provided on the beam, a first signal transmitting electrode which is provided on the beam and is electrically separated from the first driving electrode, a second driving electrode which is provided on the substrate and pulls in the first driving electrode when the electric potential is applied between the first driving electrode and the second driving electrode, a second signal transmitting electrode which is provided on the substrate, and is brought into contact with the first signal transmitting electrode when the first driving electrode is pulled in the second driving electrode, the second signal transmitting electrode being electrically separated from the second driving electrode, and a fixed electrode which is formed so as to have electrostatic power with respect to the first driving electrode, and pulls in the first driving electrode so as to separate the first driving electrode from the second driving electrode when the electric potential is applied between the first driving electrode and the fixed electrode.

### BACKGROUND OF THE INVENTION

This invention relates to a micro electromechanical systems switch (herein referred to as an “MEMS switch”), and more particularly, to an electromechanical switch capable of performing rapid response at a low driving voltage.

Nowadays, as an RF (Radio Frequency, high frequency) switch, a semiconductor RF switch using a GaAs substrate, such as a HEMT, MESFET, PIN diode is a main stream.

The RF switch means the switch utilized in a field of radio communication, especially by radio frequency. For example, an RF switch, an RF filter, an RF resonator, and so on are used in a portable wireless terminal.

Recently, for the purpose of achieving high performance and low electric consumption of the portable wireless terminal, it has been proposed to utilize a device in which not only a conventional semiconductor element but also a micro electromechanical element is employed.

The device is an electromechanical switch for conducting ON and OFF of a signal, by driving micro electrodes by electrostatic force or the like to mechanically controlling a relative distance between the electrodes. Because the electrodes are electrically contacted with each other in an ON condition of the switch, a loss between the electrodes is extremely small, and hence, it is possible to realize a switch having a low loss.

Particularly, in the RF switch which is applied to a front end part of the portable wireless terminal, a low loss and low consumption of electric power are required. Therefore, the device in which such micro electromechanical elements are employed has been expected as a useful solution.

As the switch employing such electromechanical elements, various types of switch have been heretofore proposed, almost all of which are disclosed in Non-patent Document 1.

For example, a switch employing an RF MEMS which is disclosed in Non-patent Document 1 includes one movable electrode and one fixed electrode. When DC voltage as driving and controlling voltage has been applied between the movable electrode and the fixed electrode, electrostatic force is generated, and the movable electrode is pulled-in toward the fixed electrode by the electrostatic force as a driving force. Then, the electrodes is physically contacted with each other, and an input signal from an input terminal at a side of the movable electrode is outputted to an output terminal at a side of the fixed electrode, whereby the signal is coupled.

As a method of coupling, there are a method in which metal and metal are directly contacted, and a method in which they are coupled through a capacitance, interposing an insulating body. In either method, coupling with a low loss can be achieved.

Moreover, in this switch, the electrostatic force is cancelled by nulling the driving and controlling voltage which has been applied between the electrodes. Then, the movable electrode is released by a spring force of the movable electrode itself, and will return to the original position. On this occasion, because a distance between the movable electrode and the fixed electrode is sufficiently large, a capacitance value between the electrodes is small, and they will not be coupled by capacitance. Accordingly, it is possible to interrupt the signal to be coupled between the electrodes.

In this manner, isolation can be reliably secured, by making the distance between the electrodes sufficiently large, and the loss is extremely small. Accordingly, as compared with the RF switch employing the conventional semiconductor, this switch is excellent in electrical performance (Reference should be made to Non-patent Document 1).

However, in most of the conventional MEMS switches, the driving force for releasing the movable electrode has been a spring force. For this reason, in order to obtain high releasing speed, the spring force must be increased. On the other hand, in case where the spring force is increased, the electrostatic force exceeding this spring force is required, and high driving voltage has been necessarily required in this structure.

Under the circumstances, an MEMS switch as disclosed in Patent Document 1 has been proposed. This MEMS switch employs a fictitious electrode structure in three layers, which is a simple structure, but capable of performing two operations of pulling-in and releasing by electrostatic force.

FIG. 17 is a perspective view showing an MEMS switch 100 employing the electrode structure in three layers which is disclosed in Patent Document 1. This MEMS switch 100 includes a movable electrode 103, fixed electrodes 104 for driving the movable electrode, and a fixed electrode 105 for signal transmission, which are formed on a high resistance silicon substrate 101, interposing a silicon oxide film 102.

A plurality of protrusions 107 on a side face of the movable electrode are formed on a side face of the movable electrode 103 at predetermined interval. Consequently, a recess is formed between one protrusion and an adjacent protrusion on the side face of the movable electrode. The recesses are also arranged cyclically.

On the other hand, each of the fixed electrodes 104 for driving the movable electrode is also provided with protrusions 108 which are arranged so as to correspond to the protrusions and recesses on the side face of the movable electrode. The protrusions 108 of the fixed electrode 104 for driving the movable electrode are also formed cyclically, because they are arranged so as to be surrounded by the recesses on the side face of the movable electrode, leaving a determined space. Further, the recesses of the fixed electrode 104 for driving the movable electrode are also arranged cyclically, because the recesses are formed between the adjacent protrusions, in the same manner as the recesses on the side face of the movable electrode.

FIG. 18A is a sectional view of the MEMS switch 100 taken along a line A-A in FIG. 17, showing a state where a signal is not connected from the fixed electrode 105 for signal transmission to the movable electrode 103. The fixed electrode 105 for signal transmission is disposed, interposing the silicon oxide film 102 on the high resistance silicon substrate 101.

A silicon oxide film 210 for keeping insulation between the electrodes is formed on the fixed electrode 105 for signal transmission, and the movable electrode 103 is arranged thereon, interposing a capacitance decreasing space 209. The movable electrode 103 is fixed to the substrate in areas 106 for fixing the movable electrode at both ends thereof.

FIG. 18B is a sectional view of the MEMS switch 100 taken along a line A-A in FIG. 17, showing a state where the signal is connected from the fixed electrode 105 for signal transmission to the movable electrode 103. By applying voltage between the fixed electrode 105 for signal transmission and the movable electrode 103 which are arranged interposing the silicon oxide film 102 on the high resistance silicon substrate 101, the movable electrode 103 is brought into contact with the silicon oxide film 210 for keeping insulation between the electrodes formed on the fixed electrode 105 for signal transmission, by electrostatic force. As the results, the capacitance decreasing space 209 will partly remain only in vicinity of the areas 106 for fixing the movable electrode.

In case where the voltage has been applied between the fixed electrode 105 for signal transmission and the movable electrode 103, and the movable electrode 103 has come into contact with the fixed electrode 105 for signal transmission, there is such anxiety that the electric potential cannot be maintained due to direct contact between the fixed electrode 105 for signal transmission and the movable electrode 103, and the movable electrode 103 may be separated. The silicon oxide film 210 for keeping insulation between the electrodes on the fixed electrode 105 for signal transmission will function for preventing such separation of the movable electrode 103.

FIG. 18C is a sectional view of the MEMS switch 100 taken along a line B-B in FIG. 17, showing a state where a signal is not connected from the fixed electrode 105 for signal transmission to the movable electrode 103. The fixed electrodes 104 for driving the movable electrode and the fixed electrode 105 for signal transmission are arranged interposing the silicon oxide film 102 on the high resistance silicon substrate 101. The silicon oxide film 210 for keeping insulation between the electrodes is formed on the fixed electrode 105 for signal transmission, and further, the movable electrode 103 is disposed thereon, interposing the capacitance decreasing space 209.

FIG. 18D is a sectional view of the MEMS switch 100 taken along a line B-B in FIG. 17, showing a state where the signal is connected from the fixed electrode 105 for signal transmission to the movable electrode 103. By applying the voltage between the fixed electrode 105 for signal transmission and the movable electrode 103 which are arranged interposing the silicon oxide film 102 on the high resistance silicon substrate 101, the movable electrode 103 has come into contact with the silicon oxide film 210 for keeping insulation between the electrodes on the fixed electrode 105 for signal transmission, by electrostatic force.

According to this structure, operation for switching the MEMS switch from the state where the fixed electrode 105 for signal transmission is connected to the movable electrode 103 to a switched-off state is performed, by nulling the voltage applied between the fixed electrode 105 for signal transmission and the movable electrode 103, and by applying voltage between the movable electrode 103 and the fixed electrodes 104 for driving the movable electrode. As the results of this operation, the electrostatic force will function so that a determined distance which has been generated between the movable electrode 103 and the fixed electrodes 104 for driving the movable electrode as a capacitance decreasing space may become “0”.

As the results, the movable electrode 103 is moved by two forces, namely, a spring force of the movable electrode 103 for recovering it from flexure, and the electrostatic force. Therefore, the movable electrode 103 is able to be separated from the fixed electrode 105 for signal transmission in a short time, and hence, operation performance for switching off can be enhanced.

As described above, the MEMS switch disclosed in Patent Document 1 employs the fictitious electrode structure in three layers including the movable electrode and the fixed electrodes formed on the substrate, besides, the fine comb-teeth structures at both sides of the movable electrode, and further, the fixed comb-teeth electrodes which are formed on the same layer as the movable electrode.

According to this structure, the driving voltage required for pulling-in can be decreased by making the spring force of the movable electrode as small as possible, and releasing speed which has been made slow by reducing the spring force can be compensated by the electrostatic force which is generated between the electrodes. Therefore, it is possible to realize a switch which can rapidly respond in spite of low driving voltage, even though it has a very simple structure (Reference should be made to Patent Document 1).

Non-Patent Document 1

“RF MEMS THEORY, DESIGN, AND, TECHNOLOGY” written by Gabriel M. Rebeiz, issued on Feb. 1, 2003 from John Wiley & Sons. See page 122.

Patent Document 1

JP-A-2004-253365

As described above, in the MEMS switch having the structure as shown in Patent Document 1, in the ON condition where the movable electrode has come into contact with the silicon oxide film for keeping insulation between the electrodes on the fixed electrode for signal transmission on the substrate, a capacitance is formed between the comb teeth formed at both sides of the movable electrode and the comb teeth of the fixed comb-teeth electrodes.

In order to further shorten a response time for pulling up the movable electrode, it is necessary to enhance the electrostatic force by increasing the capacitance between the comb teeth, since the movable electrode is driven by the electrostatic force through the capacitance.

FIG. 19A is a graph showing relation of the capacitance between the comb teeth with respect to the response time. In this graph, a capacitance of 30 fF (femto Farad) formed between the comb teeth is set as a reference capacitance (Co), and there is the reference capacitances (Co) which are varied up to ten times (10×Co). Further, a relation between an insertion loss and the frequency when the comb teeth are not provided is also shown in the graph.

As shown in FIG. 19A, it is necessary to make the capacitance larger than the reference capacitance, for the purpose of reducing the response time. For example, it is found that for the purpose of enlarging a gap more than 0.6 μm in 5 μs, the capacitance between the comb teeth must be increased to ten times of the reference capacitance.

However, in case where the capacitance between the comb teeth has been increased in the ON condition, the signal will leak through the capacitance between the comb teeth (parasitic capacitance), and so, it is difficult to increase the electrostatic force.

This problem is prominent, especially when a signal having a high frequency is inputted to the switch. This is because an impedance formed between the comb teeth is reciprocal to the product of the capacitance and an angular frequency of the signal, and the higher the frequency of a signal is, the smaller the impedance is. As the results, the signal will leak, and a large loss due to the leakage may be incurred.

FIG. 19B is a graph showing relation of an insertion loss of the signal which leaks from the capacitance formed between the comb teeth, with respect to the frequency. In this graph, there is also shown relation between the insertion loss and the frequency when the reference capacitance (Co) has been varied to double, four times, six times, eight times, and ten times, making the capacitance 30 fF formed between the comb teeth as the reference capacitance (Co).

It is found from FIG. 19B that in case where the capacitance is at the reference capacitance (Co), the loss is not increased up to 5 GHz band, but in case where the capacitance between the comb teeth becomes ten times of the reference capacitance (10×Co), the loss is more than 0.2 [dB] in the 5 GHz band. This is because the impedance of the capacitance formed on a contact ground has decreased. The signal leaking to the contact ground has increased, and the loss has become larger.

The inventor of this invention has found that in the conventional electromechanical switch having the fictitious electrode structure in three layers, when the capacitance between the comb teeth is increased for the purpose of enhancing the electrostatic force, the signal will leak through the capacitance between the comb teeth (parasitic capacitance). In other words, ensuring low driving voltage and rapid response of the switch by means of the electrostatic force between the comb teeth is in trade-off relation with respect to the insertion loss of the signal in the switch.

Moreover, in the electromechanical switch which is so constructed that the electrostatic force is increased by means of the comb teeth, mutual contacts between the comb teeth may occur when the fixed comb-teeth electrodes, the driving electrodes and so on have expanded by thermal expansion, and operation of the mechanical switch may be badly affected, in some cases.

### SUMMARY OF THE INVENTION

The invention has been made in view of the above described circumstances, and it is an object of the invention to provide an electromechanical switch which can perform rapid switching response with low driving voltage, even in a region having high frequency, incurring a small insertion loss.

In order to achieve the above object, according to the present invention, there is provided an electromechanical switch, comprising:

a substrate;

a beam which is mounted on the substrate at both end parts thereof;

a first driving electrode which is provided on the beam;

a first signal transmitting electrode which is provided on the beam and is electrically separated from the first driving electrode;

a second driving electrode which is provided on the substrate and pulls in the first driving electrode when the electric potential is applied between the first driving electrode and the second driving electrode;

a second signal transmitting electrode which is provided on the substrate, and is brought into contact with the first signal transmitting electrode when the first driving electrode is pulled in the second driving electrode, the second signal transmitting electrode being electrically separated from the second driving electrode; and

a fixed electrode which is formed so as to have electrostatic power with respect to the first driving electrode, and pulls in the first driving electrode so as to separate the first driving electrode from the second driving electrode when the electric potential is applied between the first driving electrode and the fixed electrode.

According to this structure, when the first driving electrode is pulled in toward the second driving electrode by applying voltage between the first driving electrode and the second driving electrode, an entirety of the beam is pulled in toward the second driving electrode. As the results, the first signal transmitting electrode comes into contact with the second signal transmitting electrode, whereby the signal will flow and the switch is in ON condition. On the other hand, when the first driving electrode is pulled up by canceling a potential difference between the first driving electrode and the second driving electrode and by applying electric potential between the fixed electrode and the first driving electrode, the entirety of the beam is pulled up to separate the first signal transmitting electrode from the second signal transmitting electrode, whereby the signal is shut off, and the switch is in OFF condition. On this occasion, electrostatic capacitance is formed between the fixed electrode and the first driving electrode. However, leakage of the signal is prevented, because the first driving electrode is electrically separated from the first signal transmitting electrode.

Preferably, the first driving electrode has a first comb-teeth portion. The fixed electrode has a second comb-teeth portion which corresponds to the first comb-teeth portion of the first driving electrode.

According to this structure, the electrostatic power formed between the fixed electrode and the first driving electrode is increased. Therefore, the pull up operation of the beam can be executed rapidly.

Preferably, the electromechanical switch further comprises a first moving electrode which moves the beam in a longitudinal direction of the beam.

According to this structure, even if comb teeth portions of the first driving electrode and the fixed electrode are contacted from each other by expansion thereof caused by the thermal expansion, the contact of the comb teeth portions can be canceled by moving the beam in the longitudinal direction.

Preferably, the first moving electrode moves the beam by electrostatic power.

Preferably, a third comb-teeth portion is formed at an end portion of the beam. A fourth comb-teeth portion, corresponding to the third comb-teeth portion, is formed on the first moving electrode. The first moving electrode pulls in the beam to move the beam when the electric potential is applied between the beam and the first moving electrode.

According to the structures, the electrostatic power formed between the end portion of the beam and the first driving electrode can be increased.

Preferably, the electromechanical switch further comprises a second moving electrode which moves the fixed electrode so as to be separated from the beam in a width direction of the beam. The first comb-teeth portion and the second comb-teeth portion respectively have tapered shapes which are respectively tapered toward distal ends thereof.

According to the above configuration, when the comb teeth portions of the first driving electrode and the fixed electrode are contacted from each other by expansion thereof caused by the thermal expansion, the contact of the comb teeth portions can be canceled by moving the fixed electrode in the width direction so as to be separated from the beam.

Preferably, the first signal transmitting electrode has a comb-teeth portion which corresponds to the second comb-teeth portion of the fixed electrode.

According to this structure, when the switch is turned from the ON condition (in contact) to the OFF condition (not in contact), an electrostatic force generated is between the fixed electrode and the first signal transmitting electrode, in addition to the electrostatic force generated between the fixed electrode and the first driving electrode thereby to pull up the beam. Therefore, it is possible to realize the switch which can rapidly respond.

Preferably, the fixed electrode is curved at a position near the first signal transmitting electrode so as to be separated from the first signal transmitting electrode.

According to this structure, in a state where the first signal transmitting electrode is in contact with the second signal transmitting electrode to flow the signal to the first signal transmitting electrode, a certain distance is maintained between the comb-teeth portion of the first signal transmitting electrode and the comb-teeth portion of the fixed electrode, because the fixed electrode is curved So as to be separated from the first signal transmitting electrode. As the results, the electrostatic capacitance formed between the first signal transmitting electrode and the fixed electrode is made smaller, and the signal is depressed from leaking through the electrostatic capacitance. Therefore, it is possible to provide the switch having a small loss even at high frequency.

Preferably, the comb-teeth portion of the first signal transmitting electrode has a pitch between comb teeth thereof, the pitch being larger than a pitch of comb teeth of the first comb-teeth portion of the first driving electrode.

According to this structure, in a state where the first signal transmitting electrode is in contact with the second signal transmitting electrode to flow the signal to the first signal transmitting electrode, the electrostatic capacitance formed between the first signal transmitting electrode and the fixed electrode is made smaller, because areas opposed between the comb teeth portions have decreased due to the larger pitch of the comb teeth of the first signal transmitting electrode and the fixed electrode. Therefore, the signal is depressed from leaking through the electrostatic capacitance, and it is possible to provide the switch having a small loss even at high frequency.

Preferably, an insulating film is formed on either one of the first signal transmitting electrode and the second signal transmitting electrode. The first signal transmitting electrode and the second signal transmitting electrode are connected to each other through a capacitance when the first driving electrode is pulled in the second driving electrode.

Preferably, the first signal transmitting electrode and the second signal transmitting electrode are connected to each other by resistance coupling when the first driving electrode is pulled in the second driving electrode.

Preferably, an insulating film is formed on either one of the fist driving electrode and the second driving electrode. The first driving electrode and the second driving electrode are connected to each other through a capacitance when the first driving electrode is pulled in the second driving electrode.

According to this structure, even in a state where the first signal transmitting electrode is in contact with the second signal transmitting electrode, a direct current will not flow, and the contacted state is maintained.

Preferably, the second signal transmitting electrode includes a first electrode portion and a second electrode portion which are electrically separated from each other. The first signal transmitting electrode is brought into contact with both the first electrode portion and the second electrode portion when the first driving electrode is pulled in the second driving electrode.

In the above configuration, when the first driving electrode is pulled in the second driving electrode by applying the voltage between the first driving electrode and the second driving electrode, the path between the first electrode portion and the second electrode portion is formed by contacting the first signal transmitting electrode with both the first electrode and the second electrode since the entire of the beam is also pulled toward the second driving electrode.

Preferably, he electromechanical switch is constructed as a switch of series type in which a signal is transmitted from the first electrode portion to the second electrode portion when the first signal transmitting electrode is brought into contact with both the first electrode portion and the second electrode portion.

Preferably, the electromechanical switch is constructed as a switch of shunt type in which the first electrode portion is grounded and the second electrode portion is connected to input and output terminals.

According to the structure, because the electric potential of the first signal transmitting electrode is indefinite, the electrostatic force is not generated between the first signal transmitting electrode and the second signal transmitting electrode. Therefore, even in case where strong electric power is applied to the second signal transmitting electrode, an erroneous operation that the first signal transmitting electrode is pulled in by the electrostatic force of the signal itself (self actuation) can be avoided.

Preferably, the beam has a turning back structure.

According to this structure, the spring force can be weakened. Therefore, with the beam having the same size, the response time is shortened. To the contrary, in order to obtain the same response time, it is possible to reduce the size of the beam.

Preferably, the first driving electrode is formed at a center part of the beam.

According to this structure, it is possible to apply a force to a position away from a fixed end of the beam. Comparing the case where the electrostatic force is applied to the center part of the beam with the case where the electrostatic force is applied to the end part of the beam, the moment is larger in case where the electrostatic force is applied to the center part of the beam, and a large displacement can be obtained with the same force. In other words, a small force is sufficient to obtain the same displacement, and it is possible to lower the voltage for driving the beam.

According to the present invention, there is also provided an electromechanical switch, comprising:

a substrate;

a beam which is mounted on the substrate at both end parts thereof;

a movable electrode which is provided on the beam and has a first comb-teeth portion;

a signal electrode which is provided on the substrate and pulls into the movable electrode when electric potential is applied between the signal electrode and the movable electrode;

a fixed electrode which has a second comb-teeth portion corresponding to the first comb-teeth portion of the movable electrode, and pulls in the movable electrode so as to separate the movable electrode from the signal electrode when the electric potential is applied between the movable electrode and the fixed electrode; and

a first moving electrode which moves the beam in a longitudinal direction of the beam,

wherein a signal flows both the signal electrode and the movable electrode when the signal electrode contacts with the movable electrode.

Preferably, the first moving electrode moves the beam by electrostatic power.

Preferably, the first moving electrode moves the beam to prevent from contacting the first comb-teeth portion with the second comb-teeth portion.

Preferably, a third comb-teeth portion is formed at an end portion of the beam. A fourth comb-teeth portion, corresponding to the third comb-teeth portion, is formed on the first moving electrode. The first moving electrode pulls in the beam to move the beam in a longitudinal direction of the beam when the electric potential is applied between the beam and the first moving electrode.

Preferably, the electromechanical switch further comprises a second moving electrode which moves the fixed electrode so as to be separated from the beam in a width direction of the beam. The first comb-teeth portion and the second comb-teeth portion respectively have tapered shapes which are respectively tapered toward distal ends thereof.

According to the invention, it is possible to provide an electromechanical switch which can perform rapid switching response at a low driving voltage, and has a small insertion loss.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a plan view of an electromechanical switch in an embodiment 1 according to the invention as seen from above;

FIG. 2A is a sectional view taken along a line A-A′ in a state where the electromechanical switch 1 is in ON condition, and FIG. 2B is a sectional view taken along a line A-A′ in a state where the electromechanical switch 1 is in OFF condition;

FIG. 3A is a sectional view taken along a line B-B′ in a state where the electromechanical switch 1 is in ON condition, and FIG. 3B is a sectional view taken along a line B-B′ in a state where the electromechanical switch 1 is in OFF condition;

FIG. 4A is a sectional view taken along a line C-C′ in a state where the electromechanical switch 1 is in ON condition, and FIG. 4B is a sectional view taken along a line C-C′ in a state where the electromechanical switch 1 is in OFF condition;

FIG. 5 shows sectional views of FIG. 1, (a1) to (f1) are sectional views taken along a line C-C′ in FIG. 1 in the order of the production steps, and (a2) to (f2) are sectional views taken along a line B-B′ in FIG. 1 in the order of the production steps;

FIG. 6A is a plan view showing an electromechanical switch in a second embodiment of the invention, and FIG. 6B is a sectional view taken along a line D-D′ in FIG. 6A;

FIG. 7A is a plan view showing an electromechanical switch in a third embodiment of the invention, and FIG. 7B shows an equivalent circuit of the electromechanical switch in the embodiment 3;

FIG. 8 is a plan view showing an electromechanical switch in a fourth embodiment of the invention;

FIG. 9 is a plan view showing an electromechanical switch in a fifth embodiment of the invention;

FIG. 10 is an enlarged view showing an essential part of the electromechanical switch in the fifth embodiment;

FIG. 11A is a view showing positional relation between the comb-teeth parts under room temperature condition, FIG. 11B is a view showing positional relation between the comb-teeth parts under high temperature condition, and FIG. 11C is a view showing positional relation between the comb-teeth parts after positions of the comb teeth have been corrected;

FIG. 12 is a plan view showing an electromechanical switch in a sixth embodiment of the invention;

FIGS. 13A and 13B are sectional views taken along a line D-D in FIG. 12;

FIG. 14A is a view showing positional relation between the comb-teeth parts under room temperature condition, FIG. 14B is a view showing positional relation between the comb-teeth parts under high temperature condition, and FIG. 14C is a view showing positional relation between the comb-teeth parts after positions of the comb teeth have been corrected;

FIG. 15 is a plan view showing an electromechanical switch in a seventh embodiment of the invention;

FIG. 16 is a plan view showing a relation between the distance from an end portion from a beam and an amount of expansion and contraction;

FIG. 17 is a perspective view showing an MEMS switch employing the conventional electrode structure in three layers;

FIGS. 18A to 18D are sectional views taken along a line A-A in FIG. 17 showing the MEMS switch employing the conventional electrode structure in three layers; and

FIG. 19A is a graph showing relation of the capacitance between the comb teeth with respect to the response time, and FIG. 19B is a graph showing relation of an insertion loss of the signal which leaks from the capacitance formed between the comb teeth, with respect to the frequency.

### DETAILED DESCRIPTION OF THE PREFERRED EMBODIMENTS

Now, an embodiment according to the invention is described in detail, referring to the drawings.

### Embodiment 1

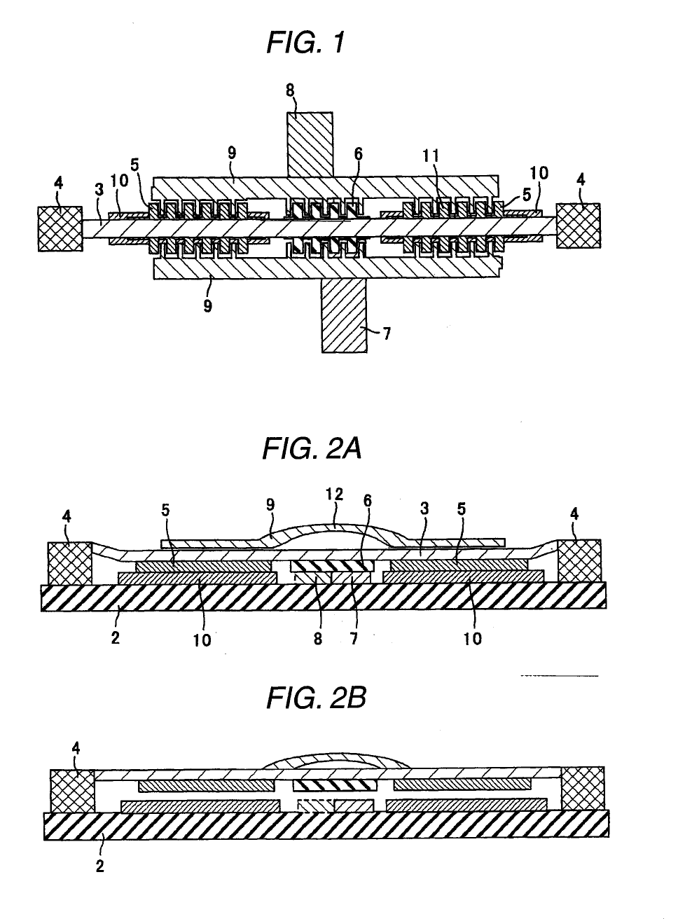

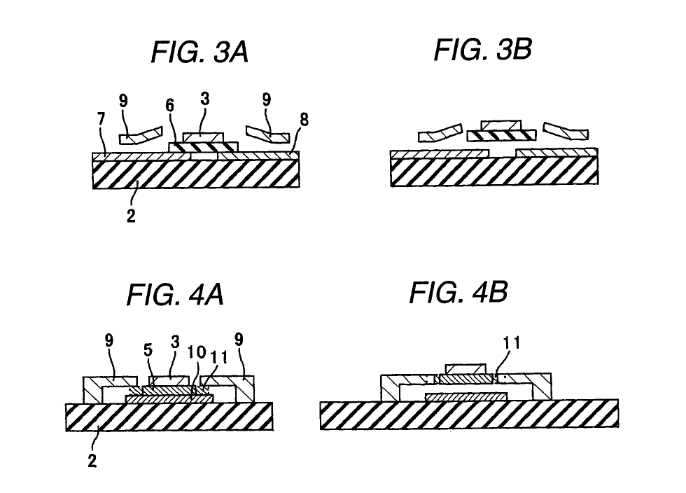

FIG. 1 is a plan view of an electromechanical switch in the embodiment 1, as seen from above. FIG. 2A is a sectional view taken along a line A-A′ in a state where the electromechanical switch 1 is in ON condition, and FIG. 2B is a sectional view taken along a line A-A′ in a state where the electromechanical switch 1 is in OFF condition. FIG. 3A is a sectional view taken along a line B-B′ in a state where the electromechanical switch 1 is in the ON condition, and FIG. 3B is a sectional view taken along a line B-B′ in a state where the electromechanical switch 1 is in the OFF condition. FIG. 4A is a sectional view taken along a line C-C′ in a state where the electromechanical switch 1 is in the ON condition, and FIG. 4B is a sectional view taken along a line C-C′ in a state where the electromechanical switch 1 is in the OFF condition.

The electromechanical switch 1 in the embodiment 1 as shown in FIG. 2 is formed on a substrate 2. As shown in FIGS. 1 and 2, a beam 3 which is fixed by post parts 4 at both ends is formed of an insulating body such as poly silicon or silicon oxide, for example, coated with an oxide film on the surface, and driving electrodes 5 and a signal transmitting electrode 6 are formed on a lower face of the beam 3 at a side opposed to the substrate.

Moreover, directly below the signal transmitting electrode 6, lower signal transmitting electrodes 7 and 8 are disposed on the substrate so as to be partially contacted with the signal transmitting electrode 6, when the beam has been displaced toward the substrate. The lower signal transmitting electrodes 7, 8 are electrically separated from each other, and respectively connected to input and output terminals which are not shown. The lower signal transmitting electrodes 7, 8 are sufficiently separated, so that the signal may not be coupled when the signal is inputted. It is possible to spatially separate the lower signal transmitting electrodes 7, 8 from each other, or to form them interposing an insulating body.

In the same manner, lower driving electrodes 10 are arranged at positions to come into contact with the driving electrodes 5 when the beam 3 has been displaced. Moreover, an insulating film is formed on surfaces of both the driving electrode 5 and the lower driving electrode 10 or either one of them, so that a direct current will not flow even in a state where they are contacted with each other.

The signal transmitting electrode 6 and the lower signal transmitting electrode 7 may be connected by capacitance coupling by forming an insulating body on the surfaces, or may be connected by resistance coupling without forming the insulating body.

A comb-teeth structure having protrusions which are cyclically formed are provided at both sides of the driving electrodes 5 and the signal transmitting electrode 6. Protrusions 11 of the comb-teeth structures of the driving electrodes 5 correspond to recesses of comb-teeth structures of fixed comb-teeth electrodes. Further, the fixed comb-teeth electrodes 9 are formed on the same layer as the driving electrodes 5 and the signal transmitting electrode 6. Each of the fixed comb-teeth electrodes 9 has a curved portion 12 which is curved upward at a position near the signal transmitting electrode 6.

According to this structure, in the electromechanical switch in this embodiment, an electric potential is applied between the lower driving electrodes 10 formed on the substrate and the driving electrodes 5 formed on the beam 3 thereby to generate an electrostatic force, whereby the driving electrodes 5, that is, the beam 3 is pulled in toward the substrate. The beam 3 is provided with the signal transmitting electrode 6 which is electrically separated from the driving electrodes 5, and the signal transmitting electrode 6 will come into contact with the lower signal transmitting electrodes 7 and 8 formed on the substrate. The lower signal transmitting electrodes 7, 8 are electrically separated from each other, and the electrically separated condition is cancelled, when the signal transmitting electrode 6 has come into contact with them.

In this manner, a path from the lower signal transmitting electrode 7 through the signal transmitting electrode 6 to the lower signal transmitting electrode 8 is formed, and the electromechanical switch 1 is in ON condition. To the contrary, when the electric potential between the lower driving electrodes 10 and the driving electrodes 5 is cancelled, and an electric potential is applied between the comb teeth by means of the comb-teeth structures which are formed between the fixed comb-teeth electrodes 9 and the driving electrodes 5, the driving electrodes 5 is pulled up toward the fixed comb-teeth electrodes, and the signal transmitting electrode 6 is also separated from the lower signal transmitting electrodes 7, 8, whereby the electromechanical switch 1 is in OFF condition.

In the ON condition of the electromechanical switch 1, an electrostatic capacitance is formed between the driving electrode 5 and the fixed comb-teeth electrode 9. Although an electrostatic capacitance is also formed between the signal transmitting electrode 6 and the fixed comb-teeth electrode 9, only a small amount of the electrostatic capacitance is formed, since the fixed comb-teeth electrode 9 is curved upward. As the results, leakage of the signal can be prevented, and it is possible to realize a switch having a low loss.

The shape of the comb teeth 9 of the fixed comb-teeth electrode is not limited to the shape as shown in FIG. 1. For example, the comb teeth may be omitted in vicinity of the signal transmitting electrode 6, or a pitch width (a distance between the comb teeth) may be larger in the vicinity of the signal transmitting electrode 6. According to this structure, in a state where the signal transmitting electrode 6 has come into contact with the lower signal transmitting electrodes 7,8 to flow the signal to the signal transmitting electrode 6, the electrostatic capacitance formed between the signal transmitting electrode 6 and the fixed comb-teeth electrode 9 becomes small, and it is possible to depress the signal from leaking through the electrostatic capacitance.

Moreover, in this embodiment, the two driving electrodes 5 are provided interposing the signal transmitting electrode 6. However, the number and arrangement of the driving electrodes and the signal transmitting electrodes are not limited to this embodiment, but one or more than three driving electrodes may be provided.

Further, it is possible to make the lower driving electrode 10 and the driving electrode 5 smaller in thickness than the signal transmitting electrode 6 and the lower signal transmitting electrodes 7, 8 so that the driving electrode 5 is not physically come into contact with the lower driving electrode 10.

Now, operation of the electromechanical switch 1 in the embodiment 1 having the above described structure is described.

In order to bring the electromechanical switch 1 into the ON condition, a control signal is applied to the driving electrode 5 and the lower driving electrode 10 for the purpose of giving an electric potential between the driving electrode 5 and the lower driving electrode 10. On this occasion, as shown in FIG. 4A, an electrostatic force is generated between the driving electrode 5 and the lower driving electrode 10 by a potential difference, and the driving electrode 5 is pulled in by the lower driving electrode 10.

When the driving electrode 5 is pulled toward the lower driving electrode 10 which is formed on the lower face of the beam 3, as shown in FIG. 2A, an entirety of the beam 3 is also pulled in toward the substrate. At the same time, the signal transmitting electrode 6 is also pulled in toward the substrate. As a result, the signal transmitting electrode 6 is physically come into contact with the lower signal transmitting electrodes 7, 8.

On this occasion, as shown in FIG. 3A, the signal transmitting electrode 6 comes into contact with a separated part between the lower signal transmitting electrodes 7 and 8 to create the path for signal transmission (ON condition). The comb teeth are also formed between the signal transmitting electrode 6 and the fixed comb-teeth electrode 9. However, because the fixed comb-teeth electrode 9 is upwardly curved near the position where the signal transmitting electrode 6 is formed, as shown in FIGS. 2A and 3A, a large electrostatic capacitance is not formed between the signal transmitting electrode 6 and the fixed comb-teeth electrode 9. As the results, it is possible to prevent leakage of the signal from the fixed comb-teeth electrode 9, and to realize a switch having a low loss.

As shown in FIGS. 2B and 3B, when the signal transmitting electrode 6 is not in contact with the lower signal transmitting electrode 7 physically (the electromechanical switch 1 is in ON condition), a signal inputted from the input terminal is not transmitted to the output terminal since the signal transmitting electrode 7 is electrically separated from the signal transmitting electrode 8 so that the signal is interrupted at the separated part (OFF condition).

In order to shift the electromechanical switch 1 from the ON condition to the OFF condition, a control signal is applied to give an electric potential between the fixed comb-teeth electrode 9 and the driving electrode 5, for the purpose of rapidly pulling up the beam 3, whereby an electrostatic force is generated. Because the electrostatic capacitance is formed between the fixed comb-teeth electrode 9 and the driving electrode 5 by means of the respective comb-teeth parts, the fixed comb-teeth electrode 9 pulls up the driving electrode 5 above the substrate with a strong force. In this manner, the beam is driven not only by the spring force but also by the electrostatic force, and hence, it is possible to drive the beam more rapidly.

As described, in the ON condition where the signal can be transmitted, leakage of the signal through the electrostatic capacitance which acts on the signal transmitting electrode 6 as the parasitic capacitance is prevented.

On the other hand, when the switch is turned off from the ON condition, the control signal between the driving electrode 5 and the lower driving electrode 10 is disconnected thereby to cancel the potential difference, while the control signal for providing a potential difference between the fixed comb-teeth electrode 9 and the driving electrode 5 is inputted. Because the electrostatic capacitance is formed between the comb-teeth part of the driving electrode 5 and the comb-teeth part of the fixed comb-teeth electrode 9, the electrostatic force is generated between the comb teeth, and hence, it is possible to rapidly pull up the beam above the substrate.

On this occasion, in case where the electric potential of the signal transmitting electrode 6 is not determined from outside but indefinite (floating; not connecting to anything), the electrostatic force of the input signals which have been inputted to the lower signal transmitting electrodes 7, 8 will not function on the signal transmitting electrode 6. Therefore, the signal transmitting electrode 6 is not pulled in by the electrostatic force. For this reason, it is possible to input a large current signal.

Then, a process for producing the electromechanical switch 1 in the embodiment 1 is described.

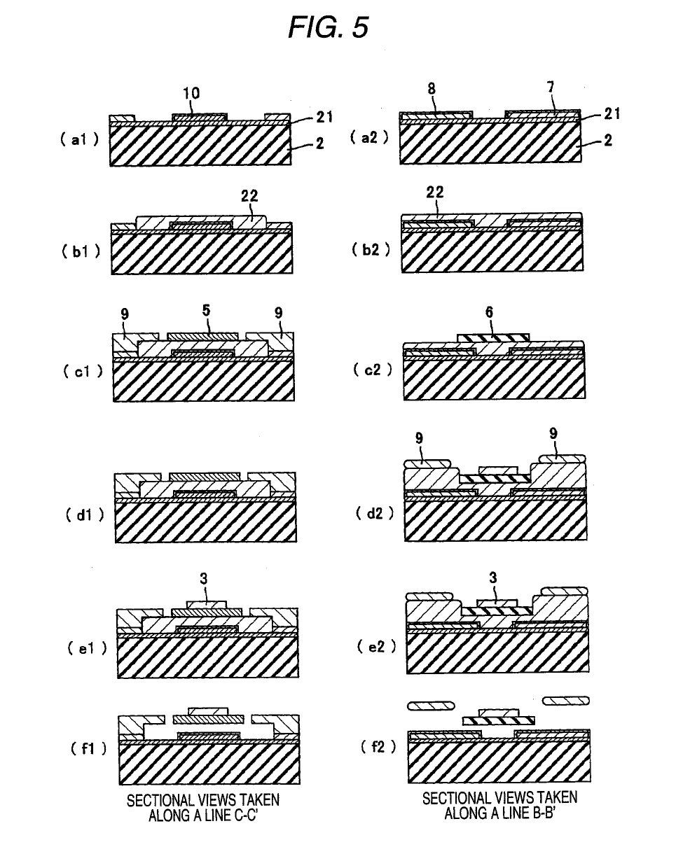

FIG. 5 shows steps for producing the electromechanical switch. FIGS. 5(a1) to (f1) are sectional views taken along a line C-C′ in FIG. 1 in the order of the production steps, and FIGS. 5(a2) to (f2) are sectional views taken along a line B-B′ in FIG. 1 in the order of the production steps.

As shown in FIGS. 5(a1) and (a2), after an insulating body 21 has been formed on the silicon substrate 2, an Al layer is deposited thereon by vacuum evaporation or spattering, and coated with a resist film having a determined pattern. Making this resist film as a mask, the Al layer is processed by wet etching or dry etching, whereby the lower driving electrode 10, and the lower signal transmitting electrodes 7, 8 is respectively formed.

Then, as shown in FIGS. 5(b1) and (b2), a resist 22 to be used as a sacrifice layer is formed, and subjected to patterning, thereby to form the sacrifice layer in a region to be a hollow structure.

Then, as shown in FIGS. 5(cd) and (c2), after an Al layer has been deposited on the upper layer by spattering, making a determined pattern as a mask, the Al layer is processed with ECR plasma by dry etching, whereby the driving electrode 5, the fixed comb-teeth electrode 9 and the signal transmitting electrode 6 is respectively formed.

Further, for the purpose of providing the fixed comb-teeth electrode 9 at an upper position in a region opposed to the signal transmitting electrode 6, a sacrifice layer is further formed on the sacrifice layer in the region opposed to the signal transmitting electrode 6, as shown in FIG. 5(d2). After an Al layer has been deposited on the upper layer by spattering in the same manner, making a determined pattern as a mask, the Al layer is processed with ECR plasma by dry etching, whereby the curved part 12 of the fixed comb-teeth electrode 9 is formed.

Then, as shown in FIGS. 5(e1) and (e2), after a poly silicon has been formed at a low temperature, the poly silicon is processed by etching, making a determined pattern as a mask, whereby the beam 3 is formed.

Finally, as shown in FIGS. 5(f1) and (f2), the sacrifice layer 22 is removed by plasma ashing to release the beam 3, and the signal transmitting electrode 6 and the driving electrode 5 which have been formed on the lower face of the beam is released, whereby a hollow structure is formed. In this manner, the electromechanical switch in the embodiment 1 is formed.

### Embodiment 2

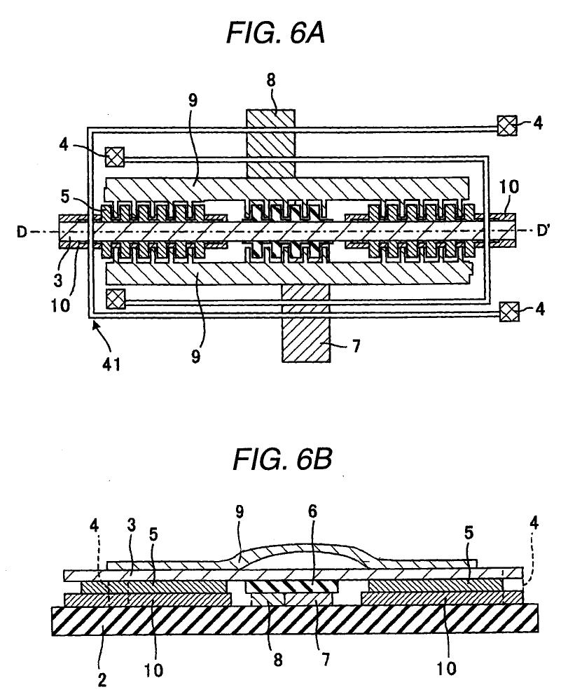

FIG. 6A is a plan view showing an electromechanical switch in a second embodiment of the invention. FIG. 6B is a sectional view taken along a line D-D′ in FIG. 6A. In the following description, the same constituent elements as the above described constituent elements is denoted with the same reference numerals, and detailed description of the elements is omitted. As compared with the embodiment 1, this embodiment is characterized in that the beam 3 is fixed by a turning back structure.

Here, the turning back structure is configured as shown in FIG. 6 that an one end of the linear beam 3 is supported on a center portion of a U shaped beam which is fixed to the substrate at the both end portions thereof, and the other end portion of the beam 3 is supported on a center portion of other U shaped beam which is fixed to the substrate at the both end portions thereof.

According to the structure for fixing the beam by turning it back, as in the embodiment 2, spring constant can be made ½. In other words, the beam 3 having the substantially same size as an entire structure of the electromechanical switch can be made flexible in spring performance, and a further rapid response can be made.

### Embodiment 3

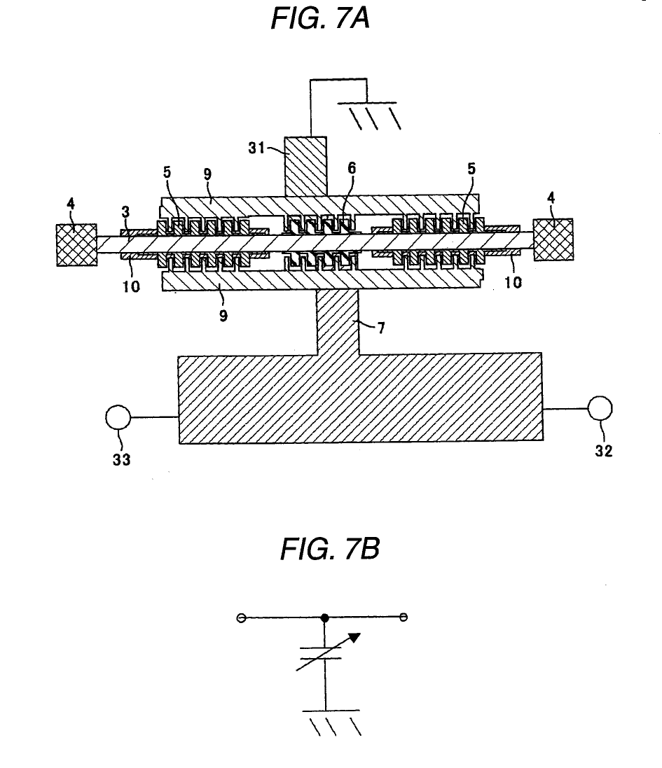

FIG. 7A is a plan view showing an electromechanical switch in a third embodiment of the invention. FIG. 7B shows an equivalent circuit of the electromechanical switch in the embodiment 3. In the following description, the same constituent elements as the above described constituent elements is denoted with the same reference numerals, and detailed description of the elements is omitted.

In the electromechanical switches in the embodiments 1 and 2, the signal is inputted from the lower signal transmitting electrode 7, and is outputted from the lower signal transmitting electrode 8 when the separated two lower signal transmitting electrodes 7, 8 are brought into contact with the signal transmitting electrode 6. In short, the switches are constructed as the switch of series type. By contrast, the switch in the embodiment 3 is characterized in that the lower signal transmitting electrode 31 is grounded, and input terminals 32, 33 are connected to the lower signal transmitting electrode 7 as shown in FIG. 7A, whereby the electromechanical switch is constructed as the switch of shunt type.

The two lower signal transmitting electrodes includes the lower signal transmitting electrode 7 and a grounding electrode 31, which is grounded. The lower signal transmitting electrode 7 is connected to an input terminal 32 and an output terminal 33.

A method of driving the beam 3 is the same as in the embodiment 1. Specifically, the beam 3 is driven by providing an electric potential between the driving electrode 5 and the lower driving electrode 10 to apply an electrostatic force, and by pulling in the signal transmitting electrode 6, the grounding electrode 31 and the lower signal transmitting electrode 7 to be electrically connected, thereby allowing the signal to be grounded. Accordingly, the signal inputted from the input terminal is grounded, but is not outputted to the output terminal, whereby the switch is in a switch-off condition.

To the contrary, in case where an electrostatic force is generated between the driving electrode 5 and the fixed comb-teeth electrode 9, and the electrostatic force which has been applied between the driving electrode 5 and the fixed comb-teeth electrode 9 is canceled, thereby the beam 3 is displaced upward so that the signal transmitting electrode 7 is separated from the grounding electrode 31. As the results, the signal inputted from the input terminal is outputted to the output terminal without being interrupted. According to this structure, it is possible to realize a switch capable of responding rapidly with a low driving voltage, even in a high frequency region.

### Embodiment 4

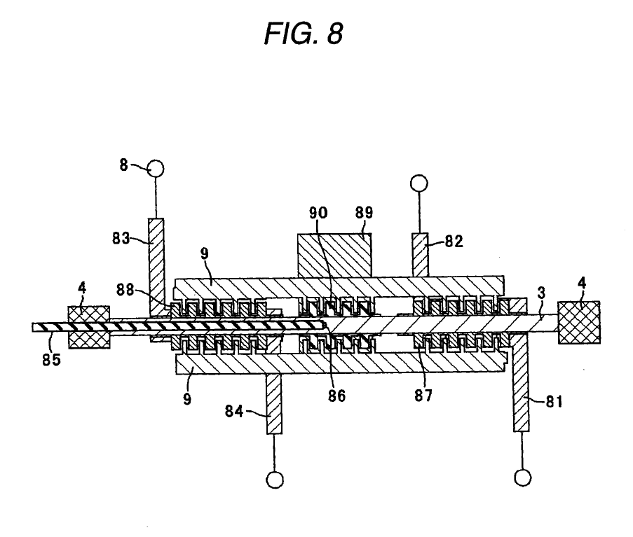

FIG. 8 is a plan view of an electromechanical switch in a fourth embodiment of the invention. In the following description, the same constituent elements as the above described constituent elements is denoted with the same reference numerals, and detailed description of the elements is omitted. As compared with the embodiments 1, 2 and 3, this embodiment is characterized in that the driving electrode is arranged in a center part of the beam 3, and the signal transmitting electrodes are arranged at both ends of the beam.

As shown in FIG. 8, a lower driving electrode 89 is arranged directly below the center part of the beam 3, and a driving electrode 90 is formed on a lower face of the beam which is opposed to the lower driving electrode 89. The beam 3 is provided with a through hole 86 for the purpose of giving an electric potential to the driving electrode 90. A control signal line 85 is connected to the upper face of the beam 3 by way of the through hole 86, and extended to the post, whereby a control signal can be inputted from outside.

Although the control signal line 85 is connected to a left end in FIG. 8, it may be connected to a right end or at both ends. Moreover, the control signal line 85 had better be thin, for the purpose of making the parasitic capacitance between the upper signal transmitting electrode 88 and the lower signal transmitting electrodes 83, 84 as small as possible. The upper signal transmitting electrode including a first upper signal transmitting electrode 87 and a second upper signal transmitting electrode 88 are formed at both sides of the driving electrode 90.

The lower signal transmitting electrode is also separated in two into a first lower signal transmitting electrode 82 and a second lower signal transmitting electrode 83 at both sides of the lower driving electrode 89. Further, the first lower signal transmitting electrode is separated into the first signal transmitting electrode 81 at a signal input side and the first signal transmitting electrode 82 at an output side, at least spatially and electrically. At the same time, the second lower signal transmitting electrode 83 is separated into the second signal transmitting electrode 84 at a signal input side and the second signal transmitting electrode 83 at an output side, at least spatially and electrically.

The electromechanical switch in the embodiment 4, in the same manner as in the embodiments 1 to 3, the electrostatic force is generated by providing an electric potential between the driving electrodes, and the beam 3 is pulled in toward the substrate, whereby the driving electrode 90 is brought into contact with the lower driving electrode 89. Consequently, the upper signal transmitting electrodes are respectively brought into contact with the lower signal transmitting electrodes at both sides of the beam 3. On this occasion, the signal inputted from the lower signal transmitting electrode 84 (the input side) is transmitted to the lower signal transmitting electrode 83 (the output side) by way of the upper signal transmitting electrode 88 to bring the switch into ON condition. In the same manner, the signal inputted from the lower signal transmitting electrode 81 (the input side) is transmitted to the lower signal transmitting electrode 82 (the output side) by way of the upper signal transmitting electrode 87 to bring the switch into ON condition.

When the electrostatic force becomes null, by canceling the electric potential between the driving electrodes, the beam 3 returns to the original position so that the upper signal transmitting electrodes are separated from the lower signal transmitting electrodes. Accordingly, the signal does not flow from the input side to the output side, thereby bringing the switch into the OFF condition. Although the switch provided with two pairs of the signal transmitting electrodes is described in this embodiment, it is apparent that one or more of the signal transmitting electrodes may be provided.

According to this structure, it is possible to apply the electrostatic force to the center part of the beam, and it is possible to apply a force to a position remote from a fixed end. Comparing the case where the electrostatic force is applied to the center part of the beam with the case where the electrostatic force is applied to the end part of the beam, the moment is larger in case where the electrostatic force is applied to the center part of the beam, and a large displacement can be obtained with the same force. In other words, a small force is sufficient to obtain the same displacement, and it is possible to decrease the voltage for driving the beam.

Even in case where electrostatic force is generated between the driving electrode and the fixed comb-teeth electrode by canceling the electrostatic force which is applied between the driving electrodes, as in the above described embodiments, leakage of the signal can be prevented. Therefore, it is possible to realize a switch capable of responding rapidly at a low driving voltage, even in a high frequency region.

### Embodiment 5

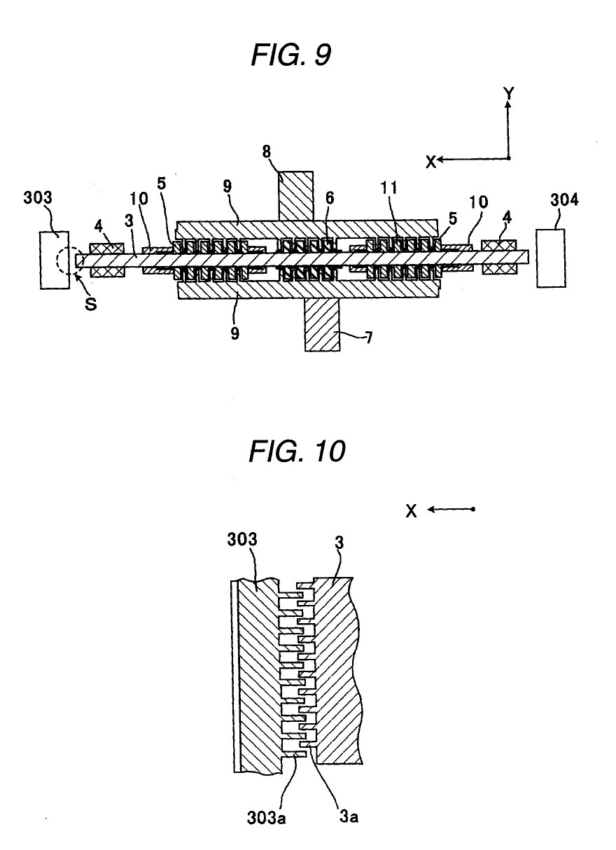

FIG. 9 is a plan view showing an electromechanical switch in a fifth embodiment of the invention. In the following description, the same constituent elements as the above described constituent elements is denoted with the same reference numerals, and detailed description of the elements is omitted. As compared with the embodiments 1 to 4, this embodiment is characterized in that moving electrodes for moving the fixed comb-teeth electrodes 9 and the beam 3 are provided on the substrate 2.

In the following description of the embodiments 5 to 7, a longitudinal direction of the beam 3 is referred to as an x direction, and a lateral direction of the beam 3 is referred to as a y direction, as shown in FIG. 9 and so on.

As shown in FIG. 9, the electromechanical switch in the embodiment 5 is provided with a moving electrode 303 for moving the beam 3 in the x direction, at a left side, along the lateral direction of the beam 3. Moreover, the electromechanical switch in the embodiment 5 is provided with a moving electrode 304 for moving the beam 3 in the x direction, at a right side, along the lateral direction of the beam 3.

The moving electrodes 303, 304 are provided for generating electrostatic force to move the beam 3 in the x direction by a distance required for avoiding mutual contact between the comb teeth of the driving electrodes 5 and the fixed comb-teeth electrodes 9. FIG. 10 is an enlarged view of an encircled part S including an end part of the beam 3, in case where a comb-teeth part is provided in the end part of the beam 3. As shown in FIG. 10, in the electromechanical switch in the embodiment 5, a comb-teeth part 3a is provided at the left end of the beam 3, and a comb-teeth part 303a corresponding to the comb-teeth part 3a of the beam 3 is provided on the moving electrode 303, for the purpose of reinforcing the electrostatic force. However, in case where there is no need to reinforce the electrostatic force, the comb-teeth parts need not be provided on the beam 3 and the moving electrode.

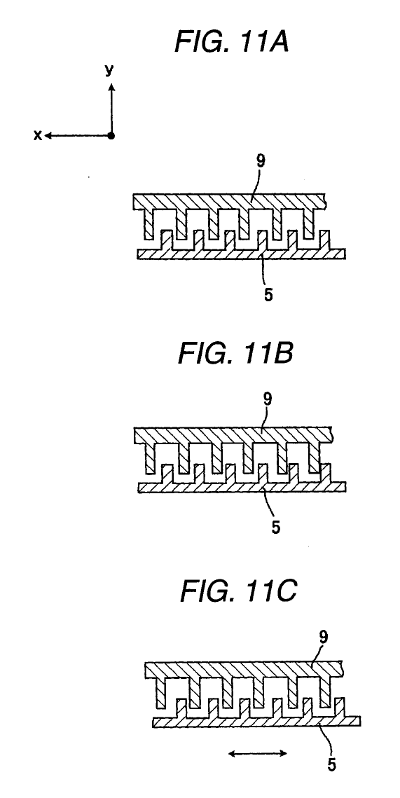

Then, referring to FIG. 11, operation for moving the beam 3 by the moving electrodes 303, 304 is described. FIG. 11A shows positional relation between the comb-teeth part of the driving electrode 5 and the comb-teeth part of the fixed comb-teeth electrode 9 under room temperature condition.

As shown in FIG. 11A, under the room temperature condition, the comb-teeth part of the driving electrode 5 and the comb-teeth part of the fixed comb-teeth electrode 9 are formed at determined intervals so that the comb-teeth parts of the driving electrode 5 and the fixed comb-teeth electrode 9 may not come into contact with each other. However, when the electromechanical switch becomes into high temperature condition, the comb-teeth part of the driving electrode 5 formed on the beam 3 is expand by thermal expansion, at positions separated from the fixed end thereof. On the other hand, expansion of the comb-teeth part of the fixed comb-teeth electrode 9 by thermal expansion is not so large, because the comb-teeth electrode 9 is positioned at a short distance from the fixed end. Consequently, as shown in FIG. 11B, the comb-teeth part of the driving electrode 5 may sometimes come into contact with the comb-teeth part of the fixed comb-teeth electrode 9 under the high temperature condition.

The moving electrodes 303, 304 are provided as means for eliminating this phenomenon. When the electromechanical switch has detected that irregular operation had happened due to contact between the comb-teeth part of the driving electrode 5 and the comb-teeth part of the fixed comb-teeth electrode 9, the beam 3 is moved in the x direction (the longitudinal direction of the beam 3) by the electrostatic force between the beam 3 and either of the moving electrodes 303 and 304.

In this manner, according to the electromechanical switch in this embodiment, it is possible to eliminate mutual contact between the comb-teeth parts, and to perform normal ON-OFF operation of the switch, employing the fixed comb-teeth electrodes 9 and the driving electrodes 5.

### Embodiment 6

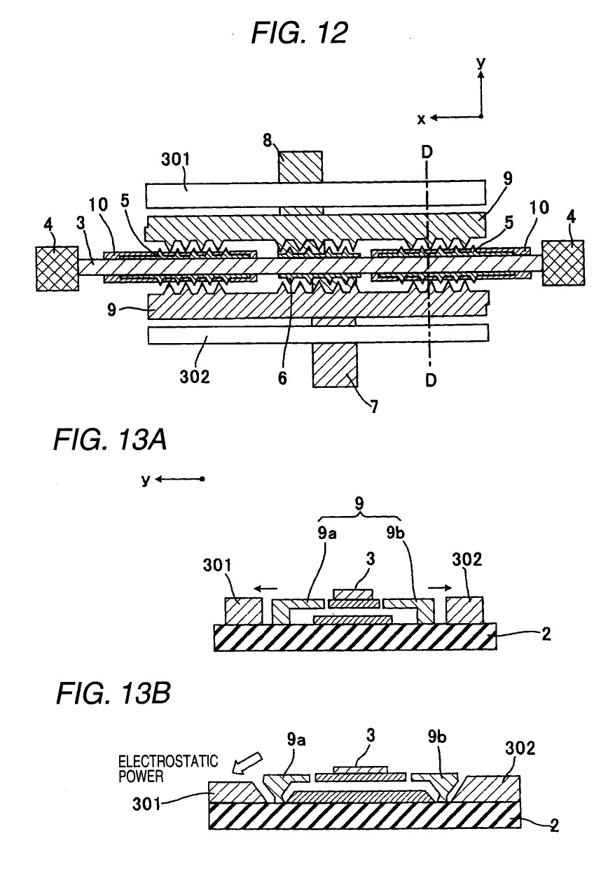

FIG. 12 is a plan view showing an electromechanical switch in a sixth embodiment of the invention. In the following description, the same constituent elements as the above described constituent elements is denoted with the same reference numerals, and detailed description of the elements is omitted. As compared with the embodiments 1 to 5, this embodiment is characterized in that moving electrodes for moving the fixed comb-teeth electrodes 9 and the beam 3 are provided on the substrate 2, and that the comb teeth in the comb-teeth part have a triangular shape which is tapered toward a distal end thereof.

As shown in FIG. 12, in the electromechanical switch in the embodiment 6, moving electrodes 301, 302 for moving the fixed comb-teeth electrodes 9 in the y direction (the lateral direction of the beam 3) by the electrostatic force are provided at both sides of the fixed comb-teeth electrodes 9. The moving electrodes 301, 302 are provided in such arrangement that they clamp the fixed comb-teeth electrodes 9 in parallel from both sides. Because the moving electrodes 301, 302 are electrically separated from the signal transmitting electrodes 7, 8, they will not badly affect the operation of the electromechanical switch.

The moving electrodes 301, 302 are provided for the purpose of moving the fixed comb-teeth electrodes 9 in a direction away from the beam 3. FIG. 13A is a sectional view taken along a line D-D in FIG. 12. As shown in FIG. 13A, the moving electrode 301 will pull-in the fixed comb-teeth electrode 9a toward the moving electrode 301 (the left side in FIG. 13) by the electrostatic force. In the same manner, the moving electrode 302 will pull-in the fixed comb-teeth electrode 9b toward the moving electrode 302 (the right side in FIG. 13) by the electrostatic force.

Moreover, it is possible to construct the moving electrodes 301, 302 and the fixed comb-teeth electrodes 9 in such a manner that the leg portions of the fixed comb-teeth electrodes 9 may be formed thinner, as shown in FIG. 13B, thereby enabling the fixed comb-teeth electrodes to be easily pulled-in toward the moving electrodes 301, 302.

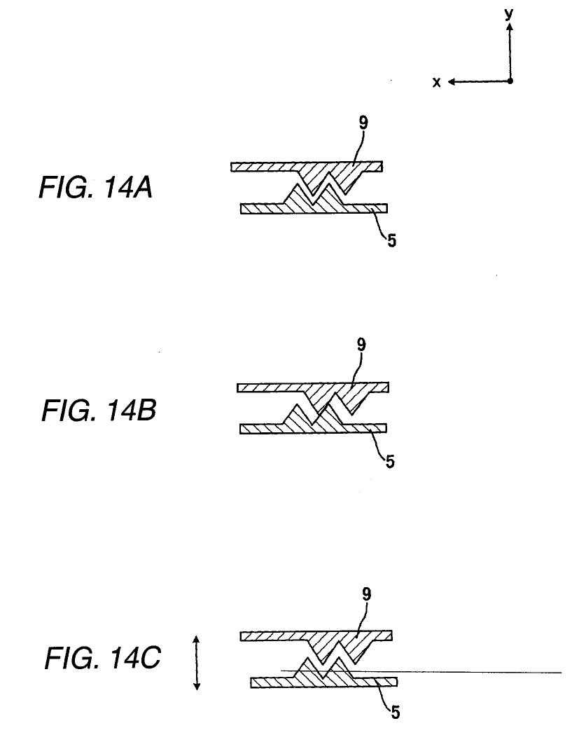

Then, referring to FIGS. 14A to 14C, operation for moving the fixed comb-teeth electrode 9 by the moving electrode 301 or 302 is described. FIG. 14A shows positional relation between the comb-teeth part of the driving electrode 5 and the comb-teeth part of the fixed comb-teeth electrode 9 under the room temperature condition.

As shown in FIG. 14A, under the room temperature condition, the comb-teeth part of the driving electrode 5 and the comb-teeth part of the fixed comb-teeth electrode 9 are formed at determined intervals so that they may not come into contact with each other. However, when the electromechanical switch has come into high temperature condition, the comb-teeth part of the driving electrode 5 may sometimes come into contact with the comb-teeth part of the fixed comb-teeth electrode 9 as shown in FIG. 14B, due to influence of the thermal expansion as described above.

The moving electrodes 301, 302 are provided as means for eliminating this phenomenon. As shown in FIG. 13A and FIG. 14C, when the electromechanical switch has detected that irregular operation had happened due to contact between the comb-teeth part of the driving electrode 5 and the comb-teeth part of the fixed comb-teeth electrode 9, for example, in case where contact between the comb teeth has happened at a side of the fixed comb-teeth electrode 9a, the fixed comb-teeth electrode 9a is moved toward the moving electrode 301 by the electrostatic force between the moving electrode 301 and the fixed comb-teeth electrode 9a. In the same manner, in case where contact between the comb teeth has happened at a side of the fixed comb-teeth electrode 9b, the fixed comb-teeth electrode 9b is moved toward the moving electrode 302 by the electrostatic force between the moving electrode 302 and the fixed comb-teeth electrode 9b.

As described above, the comb teeth in the comb-teeth part have the tapered triangular shape. Therefore, in the electromechanical switch in this embodiment, by moving the fixed comb-teeth electrode in the y direction (the lateral direction of the beam 3) so as to move apart from the beam 3 as shown in FIG. 14C, the mutual contact between the comb teeth can be eliminated. In this manner, according to the electromechanical switch in this embodiment, it is possible to eliminate mutual contact between the comb-teeth parts, and to perform normal ON-OFF operation of the switch.

It is to be noted that the shape of the comb teeth is not limited to the triangular shape, but any tapered shape such as a trapezoidal shape having its shorter side at a distal end may be employed.

### Embodiment 7

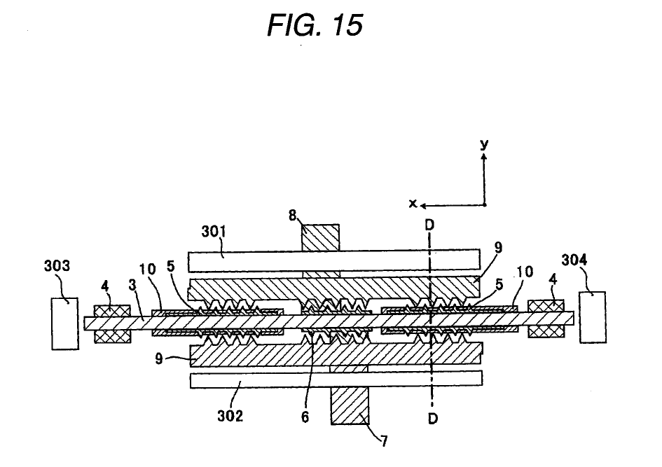

FIG. 15 is a plan view showing an electromechanical switch in a seventh embodiment of the invention. In the following description, the same constituent elements as the above described constituent elements is denoted with the same reference numerals, and detailed description of the elements is omitted. This embodiment is characterized in that both the moving electrodes for moving the fixed comb-teeth electrodes 9 and the beam 3 in the longitudinal direction, and the moving electrodes for moving the fixed comb-teeth electrodes 9 in the lateral direction are provided on the substrate 2.

As shown in FIG. 15, the electromechanical switch in this embodiment is provided with the moving electrode 303 for moving the beam 3 in the x direction, at the left side, along the lateral direction of the beam 3. Moreover, the electromechanical switch in this embodiment is provided with the moving electrode 304 for moving the beam 3 in the x direction, at the right side, along the lateral direction of the beam 3.

In addition, the electromechanical switch in this embodiment is provided with the moving electrodes 301, 302 for moving the fixed comb-teeth electrodes 9 in the y direction (the lateral direction of the beam 3) by the electrostatic force, at both sides of the fixed comb-teeth electrodes 9. The moving electrodes 301, 302 are provided in such arrangement that they clamp the fixed comb-teeth electrodes 9 in parallel from both sides. Because the moving electrodes 301, 302 are electrically separated from the signal transmitting electrodes 7, 8, they will not badly affect the operation of the electromechanical switch.

The electromechanical switch in this embodiment has such structure that the operations of the moving electrodes 301 to 304 are combined, thereby to eliminate the contact between the comb teeth. For example, when the electromechanical switch has detected that irregular operation had happened due to the contact between the comb-teeth part of the driving electrode 5 and the comb-teeth part of the fixed comb-teeth electrode 9, the beam 3 is moved in the x direction (the longitudinal direction of the beam 3) by the electrostatic force between the beam 3 and either of the moving electrodes 303 and 304.

In case where the contact still exists in either of the comb teeth, even after the beam 3 has moved in the x direction, the electromechanical switch proceeds to the next operation. For example, in case where contact between the comb teeth has happened at a side of the fixed comb-teeth electrode 9a, the fixed comb-teeth electrode 9a is moved toward the moving electrode 301 by the electrostatic force between the moving electrode 301 and the fixed comb-teeth electrode 9a. In the same manner, in case where contact between the comb teeth has happened at a side of the fixed comb-teeth electrode 9b, the fixed comb-teeth electrode 9b is moved toward the moving electrode 302 by the electrostatic force between the moving electrode 302 and the fixed comb-teeth electrode 9b.

In addition, in the description of the embodiments 5 to 7, it is described that the electromechanical switch uses a control method (hereinafter, a first control method) of detecting the contact of the comb teeth of the beam 3 and the comb teeth of the fixed comb-teeth electrode 9 and moving the beam 3 by the moving electrodes 301 to 304. However, a control method of the beam 3 is not limited to the first control method. The electromechanical switch may use a control method (hereinafter, a second control method) of providing a thermal measurement unit for measuring a temperature at vicinity of the beam 3 and moving the beam 3 by a predetermined moving amount based on a result of the measurement of the thermal measurement unit. Further, the electromechanical switch may use a method which combines the first and second control methods.

The above control methods are respectively described below for explanation.

First, the first control method will be described below. In the first control method, the beam 3 is moved in the x direction or the y direction after detecting the abnormal such as a contact of the beam 3 and the fixed comb teeth electrode 9.

As a method for detecting the abnormal such as the contact, there is a method for detecting a change of amount of capacity between the comb teeth. For example, an amount of capacity of a pair of comb-teeth portions in which comb teeth of the comb-teeth portions are formed in identically equal under the room temperature is set to C0. C0 is shown as a following formula (1). Also, an amount of capacity of the pair of comb-teeth portions in which the comb teeth of the comb-teeth portions are shifted by Δx in each other by expansion of the comb-teeth portions based on the change of the temperature is set to C′. C′ is shown as a following formula (2). In the following formulas, ε indicates dielectric constant, S indicates a dimension of a electrode, d indicates a distance between the comb-teeth portions, and Δx indicates an amount of displacement.

$$\begin{matrix}C 0 = \frac{ɛ \times S}{d} & ( 1 ) \\ {C}^{′} = C 1 + C 2 = \frac{ɛ S / 2}{( d - Δ x )} + \frac{ɛ S / 2}{( d + Δ x )} & ( 2 )\end{matrix}$$

A radio of the change of the amounts of capacities in a case that the comb teeth of the com-teeth portion are shifted by Δx is shown as a following formula (3).

$$\frac{{C}^{′}}{C 0} = \frac{{d}^{2}}{{d}^{2} - Δ {x}^{2}} \qquad ( 3 )$$

As understand from the formula (3), the capacity becomes minimum in a state that the amount of displacement Δx is zero. Therefore, the better way is to move the beam 3 in x direction (the longitudinal direction of the beam 3) so that the capacity becomes minimum for preventing from the contact based on the amount of the displacement Δx of the comb teeth of the com-teeth portion caused by the thermal change.

As a detecting method of the capacity, for example, there is a method for detecting a level of a signal flowing between the capacities. By providing a signal detecting unit at a side of the fixed comb-teeth electrode 9, the change of the capacity formed between the movable electrode 5 and the fixed comb-teeth electrode 9.

As described above, in the first control method, the change of the capacity is detected by detecting the level of the signal flowing between the capacities. Then, the amount of the displacement Δx is estimated from a detection result of the change of the capacity. Control signals based on a detection result of the amount of the displacement Δx are transferred to the moving electrodes 301 to 304 to move the beams 3, thereby the contact state of both the comb teeth from each other can be canceled.

Next, the second control method will be described as follows. In the second control method, a thermal measurement unit for measuring the temperature at vicinity of the beam 3 is provided, and the beam 3 is moved by a predetermined moving amount based on a result of the measurement of the thermal measurement unit.

Generally, a material body having a length L is expanded by ΔL when temperature is changed by ΔT. In a following formula (4) regarding ΔL, a indicates a linear expansion coefficient which is a specific value of the material.
ΔL=α·L·ΔT (4)

As understand from the formula (4), if the change of the temperature is detected, the amount of the displacement of each of the comb teeth is found by the formula (4). Therefore, it is possible to move the beam to prevent from the contact.

In a case that the pitch between the comb teeth is set to g, if an amount of displacement of one of the comb teeth located at most far away from the fixed end of the beam 3 is not greater than the amount g, the comb teeth do not contact from each other.

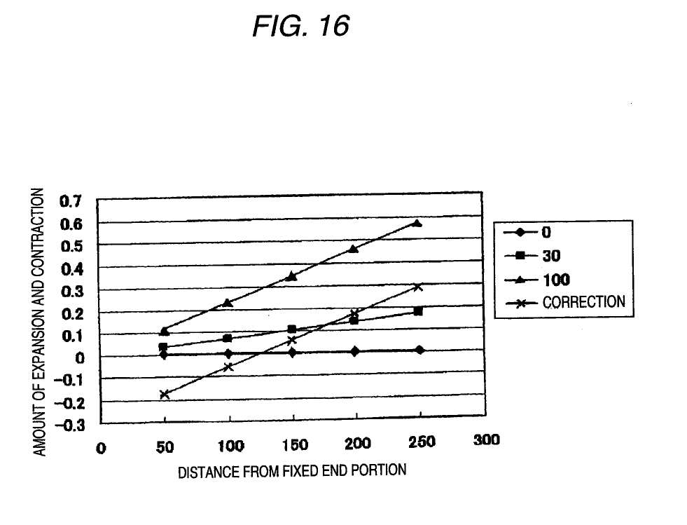

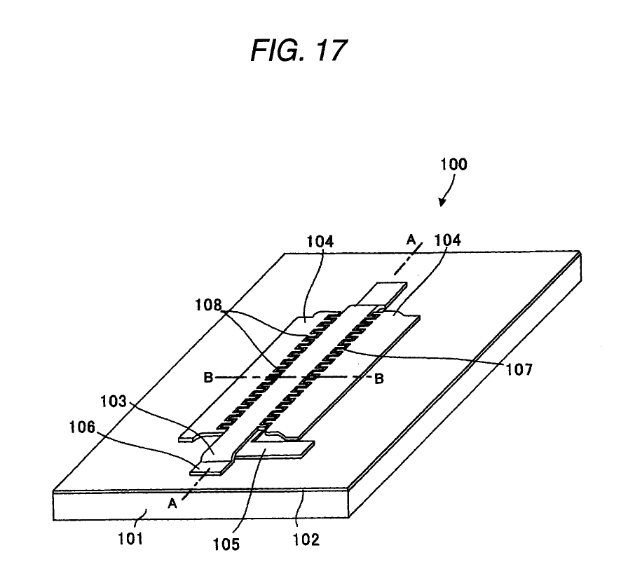

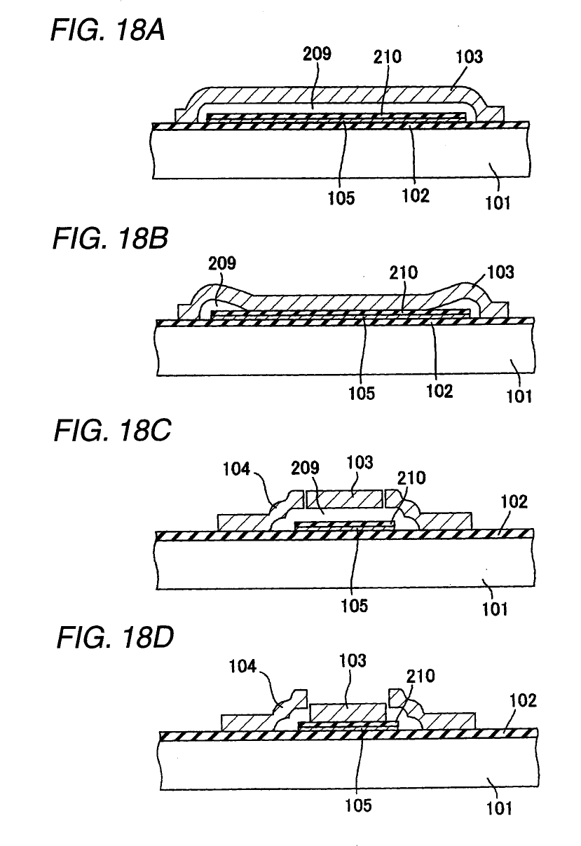

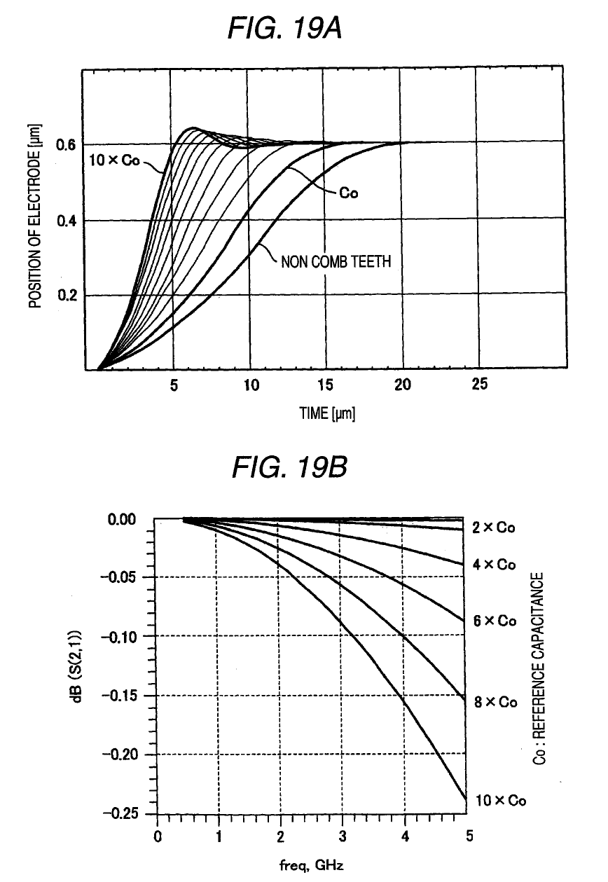

FIG. 16 shows a relationship between the distance from the fixed end of the beam 3 and the amount of expansion and contraction of comb teeth. Characteristic curves in cases of the thermal changes 10° C. (centigrade), 30° C., and 100° C. are displayed in FIG. 16. In FIG. 16, the axis of ordinate indicates the distance from the fixed end and the axis of abscissas indicates the amount of expansion and contraction.

Referring to FIG. 16, for example, the amount of displacement of a part of the comb teeth, which is separated from the fixed end by 250 μm, is 0.2 μm in a case that the gap (interval) between the comb teeth is 0.6 μm and the thermal change is 30° C. It is grasped that the contact between the comb teeth portions does not occur since an absolute value of the gap is equal to or smaller than 0.6 μm.

On the other hand, in a case that the thermal change is 100° C., the amount of displacement of a part of the comb teeth, which is separated from the fixed end by 250 μm, is 0.6 μm. Therefore, it is grasped that the contact between the comb teeth portions may occur. At this time, if the beam 3 is moved in x direction by −0.3 μm (see a correction characteristic curve in FIG. 16), the amount of expansion and contraction of a part of the comb teeth, which is separated from the fixed end by 50 μm, is about −0.2 μm and the amount of expansion and contraction of a part of the comb teeth, which is separated from the fixed end by 250 μm, is about 0.3 μm. Therefore, the contact can be canceled since absolute values of the gaps of the parts of the comb teeth at the positions (50 μm and 250 μm) are smaller than 0.6 μm.

In addition, in a case that the comb teeth have tapered shapes which are respectively tapered toward distal ends thereof as shown in FIG. 14, when the amount of displacement of a part of the comb teeth by the thermal change becomes a value greater than 0.6 μm, the contact can be canceled by moving the beam in y direction.

As described above, in the second control method, the beam 3 is moved by a predetermined moving amount by measuring a temperature at vicinity of the beam 3 so that the contact of the comb teeth portion from each other can be canceled.

Further, as described above, the first control method may be combined with the second control method. For example, the electromechanical switch includes the signal detecting unit for detecting the level of the signal flowing between the capacities and the temperature measuring unit for detecting the temperature at vicinity of the beam 3. First, the contact canceling operation based on thermal information is performed by using the second control method. When the contact has not been canceled by performing the contact canceling operation, the contact canceling operation by using the second control method may be performed. For example, if the contact of the comb teeth can not be canceled by using the operation in which the beam is moved by the predetermined amount of displacement based on the thermal information since local temperature information occurs, the beam can be moved to an optimum position for canceling the contact by using the first control method after detecting the abnormal such as the contact.

According to the electromechanical switch in this embodiment, it is possible to eliminate the contact between the comb teeth under the high temperature condition, and to realize such arrangement of the comb teeth that decrease of the electrostatic force between the comb teeth can be depressed to the minimum.

The electromechanical switch according to the invention is advantageously applied to an RF MEMS switch which can be rapidly turned on or off at a low driving voltage.

What is claimed is:

1. An electromechanical switch, comprising:
a substrate;
a beam which is mounted on the substrate at both end parts thereof;
a first driving electrode which is provided on the beam;
a first signal transmitting electrode which is provided on the beam and is electrically separated from the first driving electrode;
a second driving electrode which is provided on the substrate and pulls in the first driving electrode when the electric potential is applied between the first driving electrode and the second driving electrode;
a second signal transmitting electrode which is provided on the substrate, and is brought into contact with the first signal transmitting electrode when the first driving electrode is pulled in the second driving electrode, the second signal transmitting electrode being electrically separated from the second driving electrode; and
a fixed electrode which is formed so as to have electrostatic power with respect to the first driving electrode, and pulls in the first driving electrode so as to separate the first driving electrode from the second driving electrode when the electric potential is applied between the first driving electrode and the fixed electrode.

2. The electromechanical switch according to claim 1, wherein the first driving electrode has a first comb-teeth portion; and
wherein the fixed electrode has a second comb-teeth portion which corresponds to the first comb-teeth portion of the first driving electrode.

3. The electromechanical switch according to claim 1, further comprising a first moving electrode which moves the beam in a longitudinal direction of the beam.

4. The electromechanical switch according to claim 3, wherein the first moving electrode moves the beam by electrostatic power.

5. The electromechanical switch according to claim 4, wherein a third comb-teeth portion is formed at an end portion of the beam;
wherein a fourth comb-teeth portion, corresponding to the third comb-teeth portion, is formed on the first moving electrode; and
wherein the first moving electrode pulls in the beam to move the beam when the electric potential is applied between the beam and the first moving electrode.

6. The electromechanical switch according to claim 1, further comprising a second moving electrode which moves the fixed electrode so as to be separated from the beam in a width direction of the beam,
wherein the first comb-teeth portion and the second comb-teeth portion respectively have tapered shapes which are respectively tapered toward distal ends thereof.

7. The electromechanical switch according to claim 2, wherein the first signal transmitting electrode has a comb-teeth portion which corresponds to the second comb-teeth portion of the fixed electrode.

8. The electromechanical switch according to claim 1, wherein the fixed electrode is curved at a position near the first signal transmitting electrode so as to be separated from the first signal transmitting electrode.

9. The electromechanical switch according to claim 7, wherein the comb-teeth portion of the first signal transmitting electrode has a pitch between comb-teeth thereof, the pitch being larger than a pitch of comb teeth of the first comb-teeth portion of the first driving electrode.

10. The electromechanical switch according to claim 1, wherein an insulating film is formed on either one of the first signal transmitting electrode and the second signal transmitting electrode; and
wherein the first signal transmitting electrode and the second signal transmitting electrode are connected to each other through a capacitance when the first driving electrode is pulled in the second driving electrode.

11. The electromechanical switch according to claim 1, wherein the first signal transmitting electrode and the second signal transmitting electrode are connected to each other by resistance coupling when the first driving electrode is pulled in the second driving electrode.

12. The electromechanical switch according to claim 1, wherein an insulating film is formed on either one of the fist driving electrode and the second driving electrode; and
wherein the first driving electrode and the second driving electrode are connected to each other through a capacitance when the first driving electrode is pulled in the second driving electrode.

13. The electromechanical switch according to claim 1, wherein the second signal transmitting electrode includes a first electrode portion and a second electrode portion which are electrically separated from each other; and
wherein the first signal transmitting electrode is brought into contact with both the first electrode portion and the second electrode portion when the first driving electrode is pulled in the second driving electrode.

14. The electromechanical switch according to claim 13, wherein the electromechanical switch is constructed as a switch of series type in which a signal is transmitted from the first electrode portion to the second electrode portion when the first signal transmitting electrode is brought into contact with both the first electrode portion and the second electrode portion.

15. The electromechanical switch according to claim 14, wherein the electromechanical switch is constructed as a switch of shunt type in which the first electrode portion is grounded and the second electrode portion is connected to input and output terminals.

16. The electromechanical switch according to claim 1, wherein the beam has a turning back structure.

17. The electromechanical switch according to claim 1, wherein the first driving electrode is formed at a center part of the beam.

18. An electromechanical switch, comprising:
a substrate;
a beam which is mounted on the substrate at both end parts thereof;
a movable electrode which is provided on the beam and has a first comb-teeth portion;
a signal electrode which is provided on the substrate and pulls into the movable electrode when electric potential is applied between the signal electrode and the movable electrode;
a fixed electrode which has a second comb-teeth portion corresponding to the first comb-teeth portion of the movable electrode, and pulls in the movable electrode so as to separate the movable electrode from the signal electrode when the electric potential is applied between the movable electrode and the fixed electrode; and
a first moving electrode which moves the beam in a longitudinal direction of the beam,
wherein a signal flows both the signal electrode and the movable electrode when the signal electrode contacts with the movable electrode.

19. The electromechanical switch according to claim 18, wherein the first moving electrode moves the beam by electrostatic power.

20. The electromechanical switch according to claim 18, wherein the first moving electrode moves the beam to prevent from contacting the first comb-teeth portion with the second comb-teeth portion.

21. The electromechanical switch according to claim 18, wherein a third comb-teeth portion is formed at an end portion of the beam;
wherein a fourth comb-teeth portion, corresponding to the third comb-teeth portion, is formed on the first moving electrode; and
wherein the first moving electrode pulls in the beam to move the beam in a longitudinal direction of the beam when the electric potential is applied between the beam and the first moving electrode.

22. The electromechanical switch according to claim 18, further comprising a second moving electrode which moves the fixed electrode so as to be separated from the beam in a width direction of the beam; and
wherein the first comb-teeth portion and the second comb-teeth portion respectively have tapered shapes which are respectively tapered toward distal ends thereof.
